(19) United States
(12) Patent Application Publication
(10) Pub. No.: US 2006/0215931 A1
(43) Pub. Date: Sep. 28, 2006

(54) Image forming apparatus and computer readable medium

(75) Inventor: Hiroaki Shimomukai, Morioka-shi (JP)

Correspondence Address: NIXON PEABODY, LLP, 401 9TH STREET, NW, SUITE 900, WASHINGTON, DC, 20004-2128, US

(73) Assignee: KABUSHIKI KAISHA, Morioka-shi (JP)

(21) Appl. No.: 11/384,286

(22) Filed: Mar. 21, 2006

(30) Foreign Application Priority Data
Mar. 25, 2005 (JP) 2005-124168
Jun. 23, 2005 (JP) 2005-182956

(51) Int. Cl. G06K 9/36

(52) U.S. Cl. 382/284

(57) ABSTRACT

The present invention provides an image forming apparatus which forms a composite image obtained by combining a two-dimensional code image and an arbitrary image and having high discrimination. In an image forming routine executed by a CPU in the image forming apparatus, a converted arbitrary image is formed from a 256 gradation arbitrary image (S114) and a converted 256 gradation QR code image is formed from a QR code image (S100), a converted QR code image is formed from the QR code image (S116), and a composite image 40 obtained by combining the converted arbitrary image and the converted QR code image according to overlay at a position designate by an operator is formed (S120). Regarding first to fifth regions obtained by dividing 256 gradations from a shadow side to a highlight side, the converted arbitrary image and the converted QR code image are formed by converting gradations of pixels on the images to gradations in the second region.

### FIELD OF THE INVENTION

The present invention relates to an image forming apparatus and a computer readable medium, and in particular to an image forming apparatus which forms a composite image obtained by combining a two-dimensional code image and an arbitrary image to each other, and a computer readable medium used for forming the composite image.

### DESCRIPTION OF THE RELATED ART

Currently, in physical distribution businesses such as a convenience store or a supermarket, barcodes are used as codes for identifying goods. On the other hand, in manufacturing industries, two-dimensional codes each including an amount of information more than that in the barcode are used in order to inform downstream process or sales department of product information. The two-dimensional codes are becoming popular to people in general via media such as weekly magazines. As the two-dimensional codes, there are known various codes such as QR code developed by Nippon Denso Inc., PDF417 developed by Symbol Technologies Inc. in USA, Data Code developed by I.D. Matrix Inc. in USA, and MAXI CODE developed by United Parcel Service (UPS) Inc. in USA. Spreading of the QR code in which Chinese characters can be incorporated is significant in Japan.

The two-dimensional code is obtained by forming data represented with a binary code in cells and arranging them on a two-dimensional matrix as a pattern (e.g.: JP-A-07-254037), and it can be read by a reading device such as a two-dimensional code reader or a mobile phone having an area sensor such as a CCD.

In order to print a two-dimensional code on a printing medium, it is necessary to form a two-dimensional code image. Since each cell has a bright portion (generally, white) and a dark portion (generally, black) in the two-dimensional code, the two-dimensional code image is produced using, for example, a monochrome or gray scale bitmap, JPEG or the like, where halftone is excluded by setting pixels on a bright portion to highlight (“1” in binary) with the brightest gradation and setting pixels on a dark portion to shadow (“0” in binary) with the darkest gradation. Incidentally, according to the Japanese Industrial Standard for the QR code, since SC (symbol contrast) between a bright portion and a dark portion for each cell on the two-dimensional code is only required to be 0.2 or more (for example, JIS X 0510:2004 (Appendix K (Rule) Guide of matrix code print quality; K. 3 Comprehensive Evaluation of Symbol Grade), it is not required to a two-dimensional code image using monochrome or grayscale necessarily. (The code image may be formed using a color image.)

In the conventional two-dimensional code, however, since one color is allocated to each of the bright portion and the dark portion thereof in order to exclude a reading error in a reading device (In almost all, white (“1” in binary) corresponding to the bright portion while black (“0” in binary) corresponding to the dark portion), the two-dimensional code is constitute of arrangement of dots (cells) of black and white. When the arrangement is changed, data embedded in the two-dimensional code is destroyed, so that fanciness is poor. Since it is not intended that the data embedded in the two-dimensional code is visually recognized by eyes of a human, it is much difficult for people to recognize information contained in the two-dimensional code, or an enterprise related to the two-dimensional code or the like. Therefore, for example, a publishing industry handling printed media has paid particular care to management of the two-dimensional codes. Accordingly, assuming that a two-dimensional code image and an arbitrary image such as a mark or a character are combined as a composite image, the composite image can be visually identified by people (has image discrimination), and when the composite image is printed on a printing medium or it is displayed on a display device such as a display and the two-dimensional code (image) printed or displayed can be read without error by a reading device, the two-dimensional code will become more popular.

### SUMMARY OF THE INVENTION

In view of these circumstances, an object of the present invention is to provided an image forming apparatus which forms a composite image obtained by combining a two-dimensional code image and an arbitrary image and having image discrimination, and a computer readable medium used for forming the composite image.

In order to achieve the above object, according to a first aspect of the present invention, there is provided an image forming apparatus comprising: an image storage which stores a two-dimensional code image and arbitrary n (n≧5)-gradation image therein; a first converted image forming unit that forms a n-gradation two-dimensional code image obtained by converting the two-dimensional code image stored in the image storage to the same image format as that of the arbitrary image; a display unit which displays the n-gradation two-dimensional code image produced in the first converted image forming unit and the arbitrary image stored in the image storage on a display in an overlapping manner; a moving unit which moves at least one of the n-gradation two-dimensional code image and the arbitrary image displayed on the display in the overlapping manner relative to the other thereof based upon input information from an input unit; a position information acquiring unit which acquires position information regarding the n-gradation two-dimensional code image and the arbitrary image after the movement has been performed by the moving unit; a second converted image forming unit which forms a converted two-dimensional code image and converted arbitrary image obtained by converting gradations of respective pixels of an overlapping portion of the n-gradation two-dimensional code image and the arbitrary image with each other to predetermined gradations based upon the position information acquired by the position information acquiring unit, and color and gradation information for respective pixels of the n-gradation two-dimensional code image and the arbitrary image; and a composition image forming unit which forms a composite image obtained by combining the converted two-dimensional code image and the converted arbitrary image obtained in the second converted image forming unit by overlay based upon the position information obtained in the position information acquiring unit, wherein the second converted image forming unit, regarding at least five divided regions of a first region, a second region, a third region including a central value of then gradations, a fourth region, and a fifth region obtained by preliminarily dividing the n gradations of a shadow side to a highlight side, converts gradations of the respective pixels of an overlapping portion of the arbitrary image with the n-gradation two-dimensional code image to gradations within the shadow side except for the first and third regions when corresponding pixels of the n-gradation two-dimensional code image in the overlapping portion thereof are positioned on the shadow side, and converts the gradations of the respective pixels to gradations within the highlight side except for the third and fifth regions when the corresponding pixels of the n-gradation two-dimensional code image in the overlapping portion thereof are positioned on the highlight side; and converts gradations of respective pixels of a overlapping portion of the n-gradation two-dimensional code image with the arbitrary image to gradations within the shadow side except for the first and third regions of the at least five divided regions when the pixels are positioned in the shadow side, and converts the gradations of the respective pixels to gradations within the highlight side except for the third and fifth regions when the pixels are positioned on the highlight side.

In the first aspect, a two-dimensional code image and a n (n≧5)-gradation arbitrary image are stored in the image storage, a n-gradation two-dimensional code image obtained by converting the two-dimensional code image stored in the image storage to the same image format as that of the arbitrary image is formed in the first converted image forming unit, and the n-gradation two-dimensional code image formed in the first converted image forming unit and the arbitrary image stored in the image storage are displayed on the display in an overlapping manner. Next, at least one of the n-gradation two-dimensional code image and the arbitrary image displayed on the display in an overlapping manner is moved relative to the other according to input information from the input device by the moving unit, and position information about the n-gradation two-dimensional code image and the arbitrary image moved by the moving unit is acquired by the position information acquiring unit. Next, a converted two-dimensional code image and a converted arbitrary image obtained by converting respective pixels of an overlapping portion of the n-gradation two-dimensional code image and the arbitrary image with each other to predetermined gradation based upon the position information acquired by the position information acquiring unit and colors and gradations of respective pixels on the n-gradation two-dimensional code image and the arbitrary image is formed by the second converted image forming unit. At that time, regarding the n gradations including at least five divided regions of a first region, a second region, a third region including a central value of then gradations, a fourth region, and a fifth region obtained by preliminarily dividing the n gradations from a shadow side toward a highlight side, the second converted image forming unit converts gradations of respective pixels of the overlapping portion of the arbitrary image with n-gradation two-dimensional code image to a gradation within shadow side except for the first and third regions when corresponding pixels of the n-gradation two-dimensional code image in the overlapping portion is positioned in the shadow side, and converts respective pixels of the overlapping portion of the n-gradation two-dimensional code image with the arbitrary image to a gradation within the shadow side except for the third and fifth regions when the respective pixels are positioned in the highlight side. Further, the second converted image forming unit converts gradations of respective pixels of the overlapping portion of the n-gradation two-dimensional code image with the arbitrary image to gradations within the shadow side except for the first and third regions when the pixels are positioned in the shadow side and converts the gradations of the respective pixels to gradations within the highlight region except for the third and fifth region when the pixels are positioned in the highlight side. A composite image obtained by combining the converted two-dimensional code image and the converted arbitrary image formed in the second converted image forming unit is formed by overlay in the composite image forming unit.

According to the first embodiment, since the composite image is formed using overlay by the composite image forming unit, and the (converted) arbitrary image is included in the composite image incorporated thereto, the composite image incorporated with the (converted) two-dimensional code image can be visually identified by a person. Further, since the converted two-dimensional code image and the converted arbitrary image obtained by excluding the third region which easily causes a reading error at a time of reading performed by a reader or a reading device such as a two-dimensional code reader or a camera and converting respective pixels of the overlapping portions of the n-gradation two-dimensional code image and the arbitrary image with each other to the shadow side except for the first and third regions or the highlight side except for the third and fifth regions according to gradations of pixels of the n-gradation two-dimensional code image are formed by the converted image forming unit, (the converted two-dimensional code image portion of) the composite image formed by the composite image forming unit can be reliably read by a reading device.

In the first aspect, it is preferable that second converted image forming unit, regarding the five divided regions of the first region, the second region, the third region including a central value of the n gradations, the fourth region, and the fifth region obtained by preliminarily dividing the n gradations of a shadow side to a highlight side, converts gradations of respective pixels of an overlapping portion of the arbitrary image with the two-dimensional code image except for pixels of white color to gradation within the second region when corresponding pixels of the n-gradation two-dimensional code image in the overlapping region are positioned in the shadow side, and converts the gradations of the respective pixels to gradations within the fourth region when the corresponding pixels are positioned on the highlight side; and converts gradations of respective pixels of an overlapping portion of the n-gradation two-dimensional code image with the arbitrary image except for pixels of white color to gradations within the second region of the five divided regions when the pixels are positioned in the shadow side, and converts the gradations of the respective pixels to gradations within the fourth region when the pixels are positioned on the highlight side. In that case, such a constitution may be adopted that the second converted image forming unit further converts respective shadow pixels of an overlapping portion of the converted two-dimensional code image with white color pixels of the arbitrary image to pixels having arbitrary one color except for the color of the shadow pixels and having gradations within one of the first and second regions.

In order to achieve the above object, according to a second aspect, there is provided an image forming apparatus comprising: an image storage which stores a two-dimensional code image and arbitrary n (n≧5)-gradation image therein; a first converted image forming unit that forms a n-gradation two-dimensional code image obtained by converting the two-dimensional code image stored in the image storage to the same image format as that of the arbitrary image; a display unit which displays the n-gradation two-dimensional code image produced in the first converted image forming unit and the arbitrary image stored in the image storage on a display in an overlapping manner; a moving unit which moves at least one of the n-gradation two-dimensional code image and the arbitrary image displayed on the display in the overlapping manner relative to the other thereof based upon input information from an input unit; a position information acquiring unit which acquires position information regarding the n-gradation two-dimensional code image and the arbitrary image after the movement has been performed by the moving unit; a second converted image forming unit which forms a converted arbitrary image obtained by converting gradations of respective pixels of an overlapping portion of the arbitrary image with the n-gradation two-dimensional code image to predetermined gradations based upon position information acquired by the position information acquiring unit, and color and gradation information for respective pixels of the n-gradation two-dimensional code image and the arbitrary image; and a composition image forming unit which forms a composite image by combining the n-gradation two-dimensional code image and the converted arbitrary image based upon the position information acquired by the position information acquiring unit such that the n-gradation two-dimensional code image formed in the first converted image forming unit constitutes a background and the converted arbitrary image formed in the second converted image forming unit constitutes a foreground, wherein the second converted image forming unit, regarding at least five divided regions of a first region, a second region, a third region including a central value of the n gradations, a fourth region, and a fifth region obtained by preliminarily dividing the n gradations of a shadow side to a highlight side, converts gradations of the respective pixels of a overlapping portion of the arbitrary image with the n-gradation two-dimensional code image to gradations within the shadow side except for the first and third regions when corresponding pixels of the n-gradation two-dimensional code image in the overlapping portion thereof are positioned on the shadow side, and converts the gradations of the respective pixels to gradations within the highlight side except for the third and fifth regions when the corresponding pixels of the n-gradation two-dimensional code image in the overlapping portion thereof are positioned on the highlight side.

In the second aspect, a two-dimensional code image and a n (n≧5)-gradation arbitrary image are stored in the image storage, a n-gradation two-dimensional code image obtained by converting the two-dimensional code image stored in the image storage to the same image format as that of the arbitrary image is formed in the first converted image forming unit, and the n-gradation two-dimensional code image formed in the first converted image forming unit and the arbitrary image stored in the image storage are displayed on the display in an overlapping manner. Next, at least one of the n-gradation two-dimensional code image and the arbitrary image displayed on the display in an overlapping manner is moved relative to the other according to input information from the input device by the moving unit, and position information about the n-gradation two-dimensional code image and the arbitrary image moved by the moving unit is acquired by the position information acquiring unit. Next, a converted two-dimensional code image and a converted arbitrary image obtained by converting respective pixels of an overlapping portion of the n-gradation two-dimensional code image and the arbitrary image with each other to predetermined gradation based upon the position information acquired by the position information acquiring unit and colors and gradations of respective pixels on the n-gradation two-dimensional code image and the arbitrary image is formed by the second converted image forming unit. At that time, regarding the n gradations including at least five divided regions of a first region, a second region, a third region including a central value of the n gradations, a fourth region, and a fifth region obtained by preliminarily dividing the n gradations from a shadow side toward a highlight side, the second converted image forming unit converts gradations of respective pixels of the overlapping portion of the arbitrary image with n-gradation two-dimensional code image to a gradation within shadow side except for the first and third regions when corresponding pixels of the n-gradation two-dimensional code image in the overlapping portion is positioned in the shadow side, and converts respective pixels of the overlapping portion of the n-gradation two-dimensional code image with the arbitrary image to a gradation within the shadow side except for the third and fifth regions when the respective pixels are positioned in the highlight side. A composite image obtained by combining the n-gradation two-dimensional code (image) and the converted arbitrary code (image) utilizing the n-gradation two-dimensional code (image) formed in the first converted image forming unit as a foreground and utilizing the converted arbitrary image formed in the second converted image forming unit as a background is formed based upon the position information acquired in the position information unit by the composite image forming unit.

According to the second aspect, since a composite image including the n-gradation two-dimensional code as a background and the converted arbitrary image as a foreground is formed by the composite image forming unit, and the (converted) arbitrary image is included in the composite image, the composite image including the (n-gradation) two-dimensional code image can be visually recognized by a person. Further, since the converted arbitrary image obtained by excluding the third region which easily causes a reading error at a time of reading performed by a reading device such as a two-dimensional code reader or a camera and converting respective pixels of the overlapping portion of the arbitrary image with the n-gradation two-dimensional code image to the shadow side except for the first and third regions or the highlight side except for the third and fifth regions according to gradations of pixels of the n-gradation two-dimensional code image is formed by the second converted image forming unit, (the converted two-dimensional code image portion of) the composite image formed by the composite image forming unit can be reliably read by a reading device.

In the second aspect, it is preferable that the second converted image forming unit, regarding the five divided regions of the first region, the second region, the third region including a central value of the n gradations, the fourth region, and the fifth region obtained by preliminarily dividing the n gradations from a shadow side toward a highlight side, converts gradations of respective pixels of an overlapping portion of the arbitrary image with the n-gradation two-dimensional code image except for pixels of white color to gradations within the second region when corresponding pixels of the n-gradation two-dimensional code image in the overlapping region are positioned on the shadow side, and converts the gradations of the respective pixels to gradations within the fourth region when the corresponding pixels of the n-gradation two-dimensional code image in the overlapping portion are positioned on the highlight side. In that case, such a constitution may be adopted that the second converted image forming unit converts shadow pixels of an overlapping portion of the n-gradation two-dimensional code image with white color pixels of the arbitrary image to pixels having arbitrary one color except for the color of the shadow pixels and having gradations within one of the first and second regions.

In the first and second aspects, it is preferable that the second converted image forming unit compresses gradations of respective pixels of an overlapping portion of the arbitrary image with the n-gradation two-dimensional code image for each of R, G, and B such that the gradations enter in one of the second region and the fourth region according to whether corresponding pixels of the n-gradation two-dimensional code image in the overlapping portion are positioned on the highlight side or the shadow side. Further, the image forming apparatus may further comprise a scaled image forming unit which forms a scaled n-gradation two-dimensional code image obtained by enlarging or reducing the n-gradation two-dimensional code image formed by the first converted image forming unit, wherein the display unit displays the scaled n-gradation two-dimensional code image formed by the scaled image forming unit and the arbitrary image stored in the image storage on the display in an overlapping manner.

In order to solve the above problem, according to a third aspect of the present invention, there is provided a computer readable medium comprising a program for forming a composite image obtained by combining a two-dimensional code image and an arbitrary image, wherein the program comprises: a program code for generating an image storage which stores a two-dimensional code image and arbitrary n (n≧5)-gradation image therein; a program code for generating a first converted image forming unit that forms a n-gradation two-dimensional code image obtained by converting the two-dimensional code image stored in the image storage to the same image format as that of the arbitrary image; a program code for generating a display unit which displays the n-gradation two-dimensional code image produced in the first converted image forming unit and the arbitrary image stored in the image storage on a display in an overlapping manner; a program code for generating a moving unit which moves at least one of the n-gradation two-dimensional code image and the arbitrary image displayed on the display in the overlapping manner relative to the other thereof based upon input information from an input unit; a program code for generating a position information acquiring unit which acquires position information regarding the n-gradation two-dimensional code image and the arbitrary image after the movement has been performed by the moving unit; a program code for generating a second converted image forming unit which forms a converted two-dimensional code image and converted arbitrary image obtained by converting gradations of respective pixels of an overlapping portion of the n-gradation two-dimensional code image and the arbitrary image with each other to predetermined gradations based upon the position information acquired by the position information acquiring unit, and color and gradation information for respective pixels of the n-gradation two-dimensional code image and the arbitrary image; and a program code for generating a composition image forming unit which forms a composite image obtained by combining the converted two-dimensional code image and the converted arbitrary image obtained in the second converted image forming unit by overlay based upon the position information obtained in the position information acquiring unit, wherein the second converted image forming unit, regarding at least five divided regions of a first region, a second region, a third region including a central value of the n gradations, a fourth region, and a fifth region obtained by preliminarily dividing the n gradations of a shadow side to a highlight side, converts gradations of the respective pixels of an overlapping portion of the arbitrary image with the n-gradation two-dimensional code image to gradations within the shadow side except for the first and third regions when corresponding pixels of the n-gradation two-dimensional code image in the overlapping portion thereof are positioned on the shadow side, and converts the gradations of the respective pixels to gradations within the highlight side except for the third and fifth regions when the corresponding pixels of the n-gradation two-dimensional code image in the overlapping portion thereof are positioned on the highlight side; and converts gradations of respective pixels of a overlapping portion of the n-gradation two-dimensional code image with the arbitrary image to gradations within the shadow side except for the first and third regions of the at least five divided regions when the pixels are positioned in the shadow side, and converts the gradations of the respective pixels to gradations within the highlight side except for the third and fifth regions when the pixels are positioned on the highlight side.

In the third aspect, it is preferable that the second converted image forming unit, regarding the five divided regions of the first region, the second region, the third region including a central value of the n gradations, the fourth region, and the fifth region obtained by preliminarily dividing the n gradations of a shadow side to a highlight side, converts gradations of respective pixels of an overlapping portion of the arbitrary image with the two-dimensional code image except for pixels of white color to gradation within the second region when corresponding pixels of the n-gradation two-dimensional code image in the overlapping region are positioned in the shadow side, and converts the gradations of the respective pixels to gradations within the fourth region when the corresponding pixels are positioned on the highlight side; and converts gradations of respective pixels of an overlapping portion of the n-gradation two-dimensional code image with the arbitrary image except for pixels of white color to gradations within the second region of the five divided regions when the pixels are positioned in the shadow side, and converts the gradations of the respective pixels to gradations within the fourth region when the pixels are positioned on the highlight side.

In order to solve the above problem, according to a fourth aspect, there is provided a computer readable medium comprising a program for forming a composite image obtained by combining a two-dimensional code image and an arbitrary image, wherein the program comprises: an image storage which stores a two-dimensional code image and arbitrary n (n≧5)-gradation image therein; a first converted image forming unit that forms a n-gradation two-dimensional code image obtained by converting the two-dimensional code image stored in the image storage to the same image format as that of the arbitrary image; a display unit which displays the n-gradation two-dimensional code image produced in the first converted image forming unit and the arbitrary image stored in the image storage on a display in an overlapping manner; a moving unit which moves at least one of the n-gradation two-dimensional code image and the arbitrary image displayed on the display in the overlapping manner relative to the other thereof based upon input information from an input unit; a position information acquiring unit which acquires position information regarding the n-gradation two-dimensional code image and the arbitrary image after the movement has been performed by the moving unit; a second converted image forming unit which forms a converted arbitrary image obtained by converting gradations of respective pixels of an overlapping portion of the arbitrary image with the n-gradation two-dimensional code image to predetermined gradations based upon position information acquired by the position information acquiring unit, and color and gradation information for respective pixels of the n-gradation two-dimensional code image and the arbitrary image; and a composition image forming unit which forms a composite image by combining the n-gradation two-dimensional code image and the converted arbitrary image based upon the position information acquired by the position information acquiring unit such that the n-gradation two-dimensional code image formed in the first converted image forming unit constitutes a background and the converted arbitrary image formed in the second converted image forming unit constitutes a foreground, wherein the second converted image forming unit, regarding at least five divided regions of a first region, a second region, a third region including a central value of the n gradations, a fourth region, and a fifth region obtained by preliminarily dividing the n gradations of a shadow side to a highlight side, converts gradations of the respective pixels of a overlapping portion of the arbitrary image with the n-gradation two-dimensional code image to gradations within the shadow side except for the first and third regions when corresponding pixels of the n-gradation two-dimensional code image in the overlapping portion thereof are positioned on the shadow side, and converts the gradations of the respective pixels to gradations within the highlight side except for the third and fifth regions when the corresponding pixels of the n-gradation two-dimensional code image in the overlapping portion thereof are positioned on the highlight side.

In the fourth aspect, it is preferable that the second converted image forming unit, regarding the five divided regions of the first region, the second region, the third region including a central value of the n gradations, the fourth region, and the fifth region obtained by preliminarily dividing the n gradations from a shadow side toward a highlight side, converts gradations of respective pixels of an overlapping portion of the arbitrary image with the n-gradation two-dimensional code image except for pixels of white color to gradations within the second region when corresponding pixels of the n-gradation two-dimensional code image in the overlapping region are positioned on the shadow side, and converts the gradations of the respective pixels to gradations within the fourth region when the corresponding pixels of the n-gradation two-dimensional code image in the overlapping portion are positioned on the highlight side.

According to the first and third aspects, since the composite image is formed using overlay by the composite image forming unit, and the (converted) arbitrary image is included in the composite image incorporated thereto, the composite image incorporated with the (converted) two-dimensional code image can be visually identified by a person. Further, since the converted two-dimensional code image and the converted arbitrary image obtained by excluding the third region which easily causes a reading error at a time of reading performed by a reader or a reading device such as a two-dimensional code reader or a camera and converting respective pixels of the overlapping portions of the n-gradation two-dimensional code image and the arbitrary image with each other to the shadow side except for the first and third regions or the highlight side except for the third and fifth regions according to gradations of pixels of the n-gradation two-dimensional code image are formed by the converted image forming unit, (the converted two-dimensional code image portion of) the composite image formed by the composite image forming unit can be reliably read by a reading device.

Furthermore, according to the second and fourth aspect, since a composite image including the n-gradation two-dimensional code as a background and the converted arbitrary image as a foreground is formed by the composite image forming unit, and the (converted) arbitrary image is included in the composite image, the composite image including the (n-gradation) two-dimensional code image can be visually recognized by a person. Further, since the converted arbitrary image obtained by excluding the third region which easily causes a reading error at a time of reading performed by a reading device such as a two-dimensional code reader or a camera and converting respective pixels of the overlapping portion of the arbitrary image with the n-gradation two-dimensional code image to the shadow side except for the first and third regions or the highlight side except for the third and fifth regions according to gradations of pixels of the n-gradation two-dimensional code image is formed by the second converted image forming unit, (the converted two-dimensional code image portion of) the composite image formed by the composite image forming unit can be reliably read by a reading device.

### BRIEF DESCRIPTION OF THE DRAWINGS

FIG. 1 is a schematic configuration block diagram of an image forming apparatus to which the present invention can be applied;

FIG. 2 is a flowchart of an image forming routine executed by a CPU in a personal computer for the image forming apparatus according to a first embodiment;

FIG. 3 is a flowchart of a scaling processing subroutine showing details of step 104 of the image forming routine shown in FIG. 2;

FIG. 4 is a flowchart of an image forming routine executed by a CPU in a personal computer for an image forming apparatus according to a second embodiment;

FIG. 5 is a flowchart of a converted two-dimensional code image conversion processing subroutine showing details of step 118 of the image forming routine shown in FIG. 4;

FIG. 6 is a flowchart of an image forming routine executed by a CPU in the personal computer for an image forming apparatus according to a third embodiment;

FIG. 7 is a converted two-dimensional code image conversion processing subroutine showing details of step 119 of the image forming routine shown in FIG. 6;

FIGS. 8A to 8D are explanatory views illustratively showing images stored in a hard disk of a personal computer of an image forming apparatus, FIG. 8A being a QR code image, FIG. 8B being an arbitrary image, FIG. 8C being a composite image formed in the first embodiment, and FIG. 8D being a composite image formed in the second embodiment;

FIGS. 9A and 9B are explanatory views illustratively showing an arbitrary image and a converted QR code image which have been displayed on a display of an image forming apparatus in an overlapping manner and have been moved from an origin O, FIG. 9A showing a case that the arbitrary image is larger than the QR code image and FIG. 9B showing a case that the QR code image is larger than the arbitrary image;

FIGS. 10A and 10B explanatory diagram illustratively showing a conversion concept when an arbitrary image is converted to form a converted arbitrary image, FIG. 10A showing a case that pixels of corresponding QR code image are in shadow and FIG. 10B showing a case that pixels of corresponding QR code image are in highlight.

### DETAILED DESCRIPTION OF THE PREFERRED EMBODIMENTS

(First Embodiment)

A first embodiment of an image forming apparatus according to the present invention will be explained below with reference to the drawings

<Configuration>

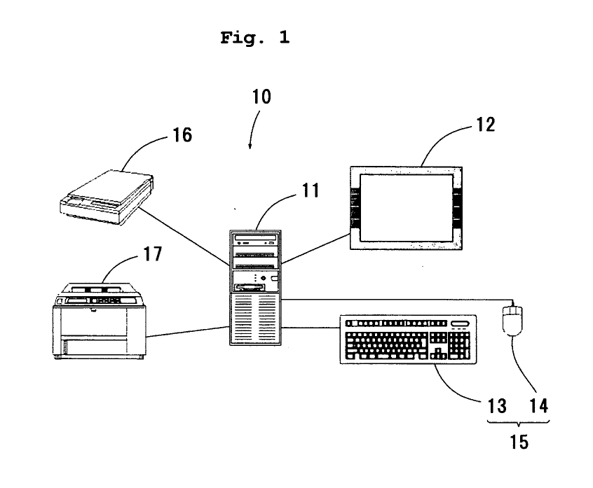

As shown in FIG. 1, an image forming apparatus 10 according to the embodiment is provided with an image storage of the present invention, a first converted image forming unit, a display unit, a moving unit, a position information acquiring unit, a second converted image forming unit, a composite image forming unit, a personal computer (hereinafter, referred to as “PC”) serving as a scaling image forming unit 11, a display 12 displaying an image according to an instruction from the PC 11, a keyboard 13 for inputting input information into the PC 11, an input device 15 such as a mouse 14, a scanner 16 which reads an image from a printed medium such as a paper or a label, and a printer 17 for printing the above-described composite image on a printing medium or a sheet, where the PC11, the display 12, the input device 15, the scanner 16, and the printer 17 are respectively connected via an interface. As known, the PC11 has a CPU, a ROM, and a RAM connected by an internal bus, and it is connected to an interface for securing connection with a hard disk (not shown) serving as an image storage and/or peripheral devices via an external bus. An application software running on OS (an operating system) of the PC11 is preliminarily installed in a hard disk in the PC11, and QR code images and arbitrary images are stored therein.

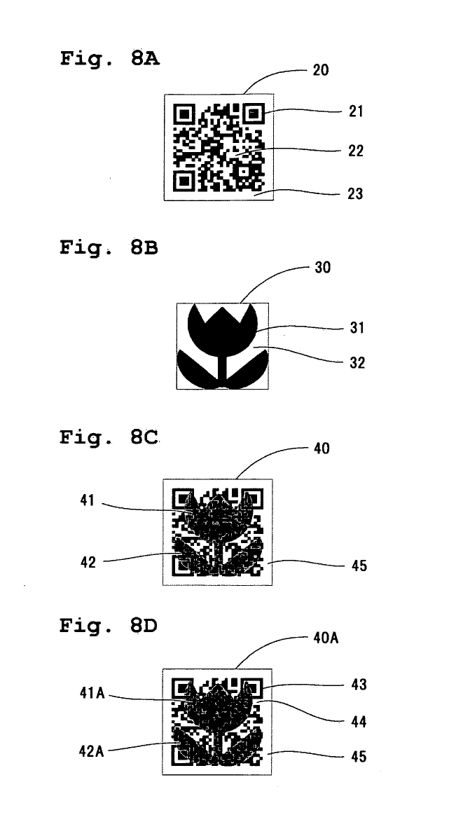

Here, referring to FIG. 8, a QR code image and an arbitrary image stored in the hard dick will be explained. Incidentally, the QR code image and the arbitrary image can be formed by the PC 11, of course, or after the QR code image and the arbitrary image are read by the scanner 16 of the image forming apparatus 10, they may be processed (modified) to be stored in the hard disk, or a QR code image and/or an arbitrary image formed in another personal computer or the like may be stored in the hard disk of the PC 11.

As shown in FIG. 8A, a QR code image 20 is constituted of three section symbols 21 (also called “eye” or “position detecting pattern”), a data area 22 where data and Reed-Solomon code are coded for each cell, timing patterns (not shown) extending in two directions of vertical and horizontal directions for obtaining a central coordinate for each cell, and a margin 23 constituting a margin space having width of 4 or more cells in an up-and-down direction and in a horizontal direction, respectively. The QR code image 20 can be formed using, for example, bitmap, JPEG, GIF or the like, but the QR code image 20 formed in an image format of monochrome bitmap is used in the following explanation.

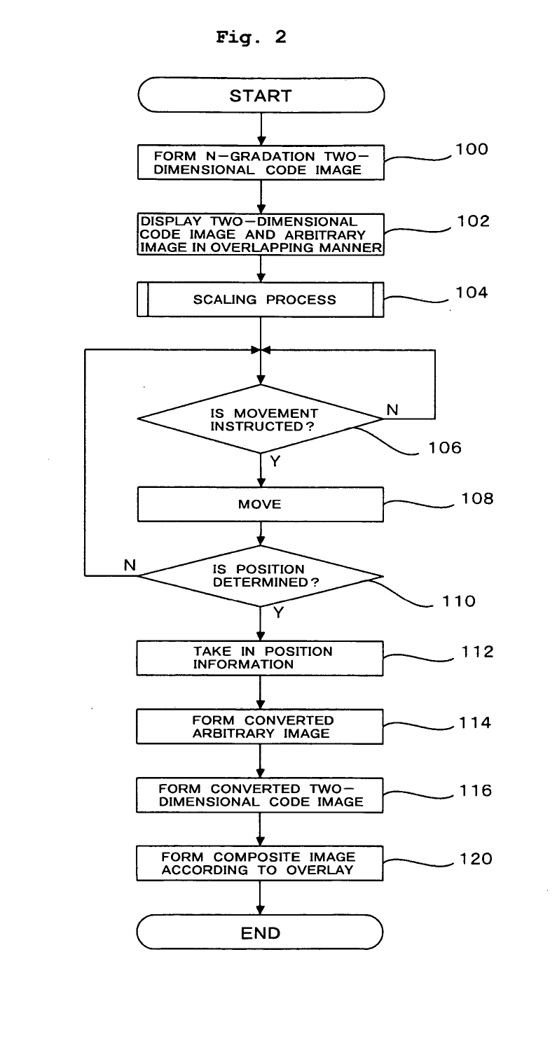

On the other hand, as shown in FIG. 8B, an arbitrary image 30 can also be formed using, for example, bitmap, JPEG, GIF, or the like, but the arbitrary image 30 formed in an image format of full color (24 bpp) bit map is used in the following explanation. Therefore, each pixel constituting the arbitrary image 30 has color information about each color of red (R), green (G), and blue (B), and a gradation information about 256 gradations (8 bits), and it is therefore constituted of 3 colors×8 bits=24 bits. More specifically, when the arbitrary image is specified, the arbitrary image 30 for this example has a color portion 31 constituted of pixels of (R, G, B)=(50, 200, 100) and forming a shape of a tulip as a whole, and a white colored portion 32 constituted of white color pixels ((R, G, B)=(255, 255, 255)). Incidentally, in the embodiment, the arbitrary image 30 must have five or more gradations in view of conversion (step 116 in FIG. 2) described later.

<Operation>

Next, referring to a flowchart, an operation of the image forming apparatus 10 will be mainly explained regarding processing in the PCU of the PC11. When an operator turns ON the PC11, the display 12, and the like constituting the image forming apparatus 10 to actuate an application software stored in the hard disk via the input device 15, an image forming routine for combining a QR code image 20 and an arbitrary image 30 to form a composite image is executed. Incidentally, the QR code image 20 and the arbitrary image 30 have already been stored in the hard disk.

As shown in FIG. 2, in the image forming routine, first, a 256-gradation QR code image 20A obtained by converting the QR code image 20 stored in the hard disk to the same full color bitmap format as an image format of the arbitrary image 30 is formed at step 100. The CPU can obtain the information about the image format of the arbitrary image 30 from header information of the arbitrary image 30. Incidentally, the image format of the arbitrary image 30 can be selected arbitrarily, and it is not required to be a full color (24 bpp) or true color (32 bpp) necessarily, that is, it may be monochrome or grayscale. Therefore, for example, when the image format of the arbitrary image 30 is a 256-gradation gray-scale, a QR code image 20A with a 256-gradation gray-scale 20A is formed.

Processing in step 100 according to the embodiment will be described in detail. Pixels with white color on the QR code image 20 are converted to highlight, namely, (R, G, B)=(255, 255, 255) on the QR code image 20A, while pixels with black color on the QR code image 20 are converted to shadow, namely, (R, G, B)=(0, 0, 0) on the QR code image 20A. In the embodiment, therefore, pixels with halftones (intermediate gradations), namely, pixels in a range of (R, G, B)=(1 to 254, 1 to 254, 1 to 254) are not present in the QR code image 20A.

In the next step 102, the QR code image 20A formed in step 100 and the arbitrary image 30 stored in the hard disk are displayed on the display 12 in an overlapping manner. That is, the CPU provides image information data about the QR code image 20A and the arbitrary image 30 and a command for displaying these images in an overlapping manner to (a display controller of) the display 12, and the display 12 displays thereon an image obtained by overlapping the QR code image 20A and the arbitrary image 30 with each other. The reason why the 256-gradation QR code image 20A having the same image format as the arbitrary image 30 is formed in the above-described step 100 is because any trouble is not caused on the display 12 when both the images are overlapped with each other in the step 102, and formation of a converted QR code image is prepared in step 116 described later. Therefore, in step 102, even if either one of the QR code image 20A and the arbitrary image 30 is displayed on the display 12 as background (or foreground), no trouble occurs regarding displaying on the display 12.

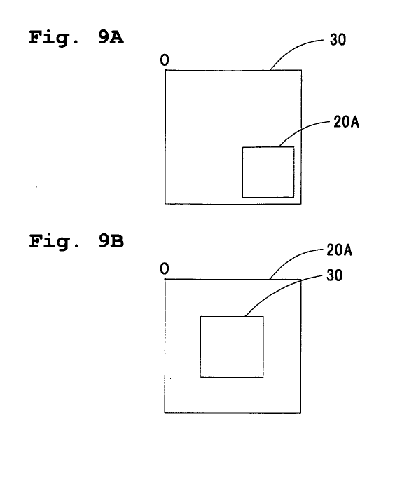

In the next step 104, a scaling process for forming a scaled QR code image 20B (not shown) obtained by enlarging or reducing (scaling) the QR code image 20A formed in step 100 is executed. The scaling process in the step 104 is optional and it is not essential step for this invention. That is, as shown in FIGS. 9A and 9B, the present invention can be applied to a case that one of the QR code image 20 (or the QR code image 20A) and arbitrary image 30 is larger than the other thereof. Theoretically, it is not problematic in that any one of the QR code image 20A and the arbitrary image 30 is scaled, but when the arbitrary image 30 in the full color bitmap format is enlarged or reduced, an image with a different gradation may occur due to addition or deletion of pixels, so that the QR code image 20A is scaled in this embodiment especially considering such a case that the arbitrary image 30 represents a mark such as a trademark for a specific company or a character(s) such as a logo. As described above, this is because the QR code image 20A constituted of only shadow pixels and highlight pixels is not affected by pixel addition and/or pixel deletion.

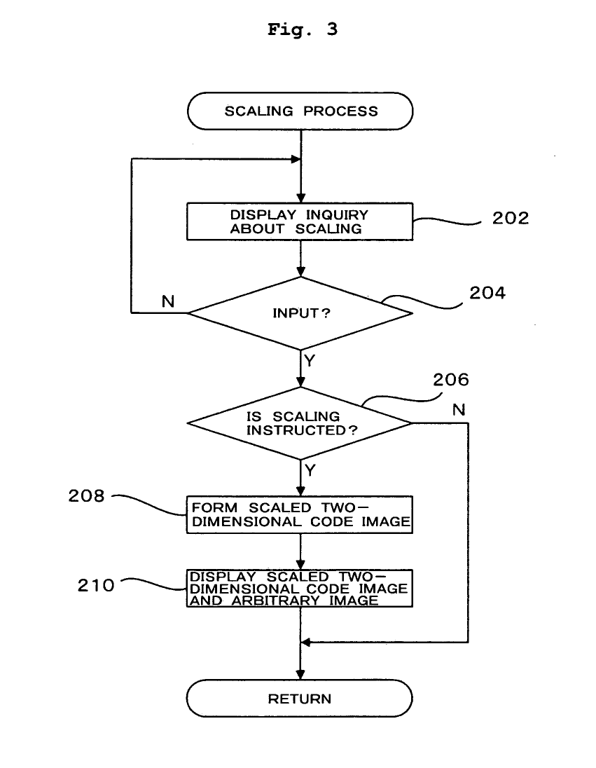

In the scaling process at step 104, as shown in FIG. 3, the scaling process subroutine is called. In the scaling process subroutine, a dialogue of an inquiry about enlargement or reduction (scaling) or the like is displayed on the display 12 at step 202, and the process is put in a standby state until input is received from the input device 15 (step 204). When input is received, whether or not a scaling instruction is issued is determined at step 206. When determination is negative at step 206, the scaling processing subroutine is terminated and the control proceeds to step 106. When determination is affirmative at the step 206, a scaled QR code image 20B (not shown) obtained by scaling the QR code image 20A according to a scaling (enlarging or reducing) instruction (a step of taking in the scaling instruction is omitted in FIG. 3) is formed at step 208. Incidentally, the scaled QR code image 20B also has 256 gradations in the same image format as that of the QR code image 20A.

In this case, for example, a scaled QR code image 20B obtained by performing scaling such that a size of a data region (see reference numeral 22 in FIG. 8A) on the QR code image 20A becomes approximately equal to the size of the arbitrary image 30 may be formed. The reason because the scaling is performed such that the size of the data region on the QR code image 20A becomes approximately equal to the size of the arbitrary image 30 is because it is desirable according to the standard described in Non-Patent Literature 1 described above that a margin (also see reference numeral 23 in FIG. 8A) does not overlap the arbitrary image 30 while it is kept in white color ((R, G, B)=(255, 255, 255)).

Next, the scaled QR code image 20B formed at step 208 and the arbitrary image 30 are displayed on the display 12 in an overlapping manner, the scaling process subroutine is terminated, and the control proceeds to step 106 in FIG. 2. In FIG. 3, for simplification of explanation, an example where the scaling instruction is received only one time has been described, but such a constitution may be adopted that the control returns from step 210 to step 202, an inquiry about scaling is performed at step 202 again, and when the scaling instruction at step 206 indicates termination of the scaling process, the scaling process subroutine is terminated.

At step 106 shown in FIG. 2, the control is put in a standby state until input is received from the input device 15, and upon receipt of input, at least one of the QR code image 20A (or the scaled QR code image 20B, same in the following description) and the arbitrary image 30 displayed on the display 12 in an overlapping manner is moved relative to the other according to input information from the input device 15 at step 108. For example, FIG. 9A shows an example that the QR code image 20A has been moved from the origin 0 without moving the arbitrary image 30 from the origin O (where the arbitrary image 30 is first displayed at step 102), while FIG. 9B shows an example that the arbitrary image 30 has been moved without moving the QR code image 20A from the origin O (where the QR code image 20A is first displayed at step 102). Incidentally, both the QR code image 20A and the arbitrary image 30 may be moved from their origin O, and the QR code image 20A and the arbitrary image 30 may overlap with each other only partially. Therefore, for example, the CPU can be configured to display a message box representing alarm or warning on the display 12, or the like when the overlapping portion of the QR code image 20A and the arbitrary image 30 with each other is cancelled.

At the next step 110, it is determined according to input information from the input device 15 whether or not a position of the overlapping portion of the QR code image 20A and the arbitrary image 30 with each other has been decided. For example, the CPU can determine whether or not a position of the overlapping portion of the QR code image 20A and the arbitrary image 30 with each other has been decided according to determination about whether a predetermined key on the keyboard 13 has been pressed or a cursor has been positioned on a command button which has been preliminarily displayed on the display 12 and a mouse has been clicked by an operator.

When the determination is negative at step 110, the control returns back to step 106 for continuing movement of the QR code image 20A and/or the arbitrary image 30. When the determination is affirmative, position information about the QR code image 20A and the arbitrary image 30 is taken in at the next step 112. Thereby, the CPU can obtain position information (x, y) of each pixel of both images in vertical and horizontal directions regarding the overlapping portion (also see FIGS. 9A, 9B, and 8C) of the QR code image 20A and the arbitrary image 30 with each other.

At the next step 114, a converted arbitrary image 30A obtained by converting gradations of the respective pixels on the overlapping portion of the arbitrary image 30 with the QR code image 20A based upon the position information about the QR code image 20A and the arbitrary image 30 taken in at step 112 and color and gradation information about the respective pixels of the QR code image 20A and the arbitrary image 30 is formed.

That is, (I) regarding five divided regions of a first region, a second region, a third region including a central value of 256 gradations, a fourth region, and fifth region obtained by preliminarily diving the 256 gradations from a shadow side to a highlight side, a converted arbitrary image 30A where (i) gradations of respective pixels of the overlapping portion of the arbitrary image 30 with the QR code image 20A are converted to gradations in the second region when the pixels of the QR code image 20A corresponding to the overlapping portion (a position of the overlapping portion) are positioned on the shadow side ((R, G, B)=(0, 0, 0) in this example) and (ii) the gradations of the respective pixels are converted to gradations in the fourth region when the pixels of the QR code image 20A corresponding to the overlapping portion are positioned on the highlight side ((R, G, B)=(255, 255, 255)) is formed.

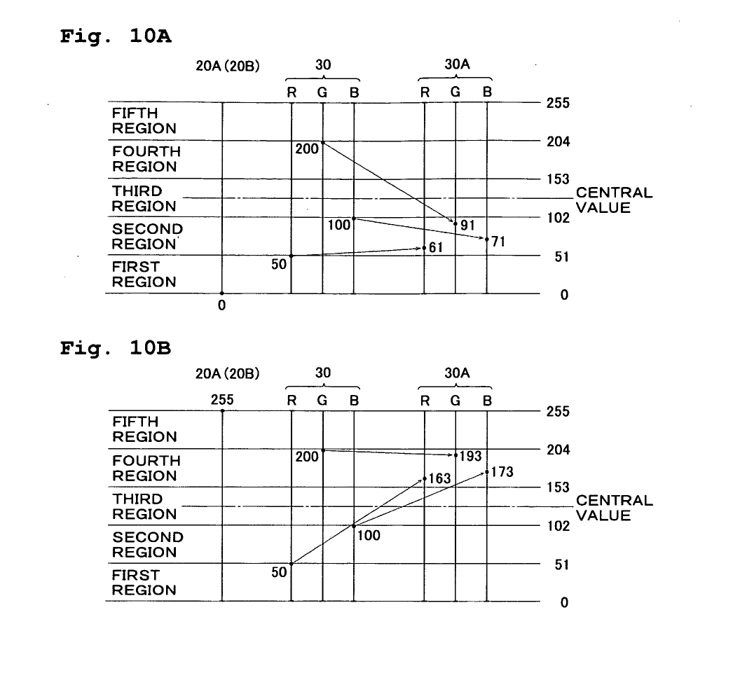

FIG. 10A is an explanatory diagram showing conversion concept of the above (I) (i). As described above, both the QR code image 20A and the arbitrary image 30 have 256 gradations, and FIG. 10A shows an example where the first region including a gradation value range of 0 to 51, the second region including a gradation value range of 52 to 102, the third region including the central value of 256 gradations and including a gradation value range of 103 to 153, the fourth region including a gradation value range of 154 to 204, and the fifth region including a gradation value range of 205 to 255 has been set by dividing the 256 gradations to five group equally. As shown in FIG. 10A, when the pixels of the QR code image 20A are positioned on the shadow side (which is shown in a simplified manner in FIG. 10A), respective pixels (R, G, B)=(50, 200, 100) constituting a colored portion 31 (see FIG. 8B) on the arbitrary image 30 are compressed to gradation values in the second region for each of R, G, and B. For example, R is compressed from 50 to 51+51×50/256=61, G is compressed from 200 to 51+51×200/256=91, and B is compressed from 100 to 51+51×100/256=71, respectively, so that respective pixels constituting the colored portion on the converted arbitrary image 30A become (R, G, B)=(61, 91, 71). On the other hand, When pixels on the QR code image 20A are positioned on the shadow side, respective pixels (R, G, B)=(255, 255, 255) constituting a white color portion 32 (see FIG. 8B) on the arbitrary image 30 are similarly compressed to gradation values in the second region for each of R, G, and B, so that pixels of (R, G, B)=(102, 102, 102) can be obtained on the converted arbitrary image 30A.

FIG. 10B is an explanatory diagram showing conversion concept of the above (I) (ii), where when pixels on the QR code image 20A are positioned on the highlight side (which is represented in a simplified manner in FIG. 10B), respective pixels (R, G, B)=(50, 200, 100) constituting the colored portion 31 on the arbitrary image 30 are compressed to gradation values in the fourth region for each of R, G, and B. For example, R is compressed from 50 to 153+51×50/256=163, G is compressed from 200 to 153+51×200/256=193, and B is compressed from 100 to 153+51×100/256=173, respectively, respective pixels constituting the colored portion on the converted arbitrary image 30A become (R, G, B)=(163, 193, 173), respective pixels (R, G, B)=(255, 255, 255) constituting the white color portion 32 on the arbitrary image 30 are also compressed to gradation valued in the fourth region for each of R, G, and B, and pixels of (R, G, B)=(204, 204, 204) can be obtained on the converted arbitrary image 30A.

Incidentally, the third region is an unrecommended region for utilization where, since it is difficult to make determination about whether pixels on the QR code image belongs to the highlight side or the shadow side, a reading error occurs easily in such a reader as a two-dimensional code reader or a camera. On the other hand, the first region is an unrecommended region for utilization where, when a person views a composite image obtained in step 120 described later on the display 12, the converted arbitrary image portion becomes too dark (appearing to be blackish) so that visual recognition becomes difficult. On the contrary, the fifth region is an unrecommended region where a portion of the converted arbitrary image becomes too light (appearing to be whitish) so that visual recognition becomes difficult.

At the next step 116, a converted QR code image 20C (not shown) obtained by converting gradations of respective pixels on the overlapping portion of the QR code image 20A with the arbitrary image 30 based upon position information of the QR code image 20A and the arbitrary image 30 taken in at step 112 and color and gradation information about each of the pixels on the QR code image 20A and the arbitrary image 30 is formed.

That is, (II) a converted QR code image 20C where (i) gradations of respective pixels on the overlapping portion of the QR code image 20A with the arbitrary image 30 is converted to gradations in the second region when the pixels on the QR code image 20A are positioned on the shadow side, while (ii) the gradations thereof are converted to gradations in the fourth region when the pixels on the QR code image 20A is positioned on the highlight side is formed. That is, specifically speaking, (i) the shadow pixels of the QR code image 20A (R, G, B)=(0, 0, 0) on the overlapping portion of the QR code image 20A with the arbitrary image 30 are converted to (R, G, B)=(102, 102, 102) on the converted QR code image 20C, while (ii) the highlight pixels of the QR code image 20A (R, G, B)=(256, 256, 256) on the overlapping portion of the QR code image 20A with the arbitrary image 30 are converted to (R, G, B)=(204, 204, 204) on the converted QR code image 20C.

At the next step 120, the converted arbitrary image 30A formed at step 114 is disposed on a position of the arbitrary image 30 taken in at step 112, the converted QR code image 20C formed at step 116 is disposed on a position of the QR code image 20A taken in at step 112, a composite image 40 obtained by combining the converted arbitrary image 30A and the converted QR code image 20C using overlay is formed, and the composite image 40 is stored in the hard dick so that the image forming routine is terminated. Incidentally, FIG. 8C illustratively shows the composite image 40 thus formed.

In general, as a technique for combining two images, there are known addition, subtraction, multiplication, overlay, and the like. The addition is a technique for adding foreground color to background color, where pixels of a composite image obtained by adding pixels of the converted arbitrary image 30A in the second region and pixels of the converted QR code image 20C in the second region often enter in the third region due to increase in gradation values of (R, G, B) caused by the addition, the converted arbitrary image portion on the composite image can be recognized by a person but the composite image tends to become too bright, and a reading error may occur in the reader, as described above. On the contrary, the subtraction is a technique for subtracting foreground color from background color, where since gradation values of (R, G, B) become small due to the subtraction, pixels on the composite image obtained by subtracting pixels of the converted QR code image 20C in the fourth region from pixels of the converted arbitrary image 30A in the fourth region (or vise versa) often enter in the third regions, the converted arbitrary image portion on the composite image can be recognized by a person but the composite image tends to become too dark, and a reading error may occur in the reader. The multiplication is a technique for multiplying background color and foreground color, where since the gradation values of (R, G, B) become small due to the multiplication, a problem similar to that in the subtraction occurs.

On the other hand, since the overlay causes a multiplication-like result when background color is dark, while it causes a screen-like result when the background color is bright, pixels of the composite image (one of the converted arbitrary image 30A and the converted QR code image 20C may constitute background and the other may constitute foreground) obtained by combining pixels on the converted arbitrary image 30A in the fourth region and pixels on the converted QR code image 20C in the fourth region using overlay enter in the fourth region or the fifth region, and pixels on the composite image obtained by combining pixels on the converted arbitrary image 30A in the second region and pixels on the converted QR code image 20C in the second region using overlay enter in the first region or the second region without entering in the third region, so that the converted arbitrary image portion on the composite image can be recognized by a person and a reading error does not occur in the reader.

<Operation and the Like>

Next, operation, advantage and the like of the image forming apparatus 10 according to the embodiment will be explained.

In the image forming apparatus 10 according to the embodiment, a converted arbitrary image 30A is formed from an arbitrary image 30 (step 114), a 256 gradation QR code image 20A is formed from a QR code image 20 (step 100), a converted QR code image 20C is formed from the QR code image 20A (step 116), and the converted arbitrary image 30A and the converted QR code image 20C are combined according to overlay at a position designated by an operator (step 102, and steps 106 to 112), so that a composite image 40 is formed (step 120). Since the composite image 40 includes the converted arbitrary image 30A, a person can visually identify the composite image 40 combined with the converted QR code image 20C as compared with a case that a person views the QR code image 20 alone (also see FIG. 8C).

In the image forming apparatus 10 according to the embodiment, regarding an overlapping portion of the QR code image 20A and the arbitrary image 30 with each other, a converted QR code image 20C and a converted arbitrary image 30A where respective pixels of the QR code image 20A and the arbitrary image 30 are converted to the second region or the fourth region except for the third region where a reading error easily occurs at a time of reading performed by a reader according to gradations of the pixels of the QR code image 20A are formed (steps 114 and 116), and a composite image 40 is formed according to overlay (step 120), so that the composite image 40 (a converted QR code image 20C portion included in the composite image 40) can be reliably read using a reader. That is, for example, the composite image 40 displayed on the display 12 can be read using such a reader as a two-dimensional code reader or a camera, and even if the composite image 40 stored in the hard disk is displayed on, for example, a digital television set, it can be read using a reader. Even if image data of the composite image 40 is outputted to the printer 17 to be printed on such a printing medium such as a paper or label in the printer 17, the printed composite image can be read by the reader.

In the image forming apparatus 10 according to the embodiment, since it is possible to form a scaled QR code image 20B obtained by scaling (enlarging or reducing) the QR code image 20A (step 104), a compact composite image 40 can be formed according to a size of the arbitrary image 30.

(Second Embodiment)

Next, a second embodiment of the image forming apparatus according to the present invention will be explained. The embodiment has a form enhancing visibility or fanciness of a composite image. In this and subsequent embodiments, same constituent portions or steps as those in the first embodiment are attached with same reference numerals, and explanation thereof is omitted so that only different points from the first embodiment is explained.

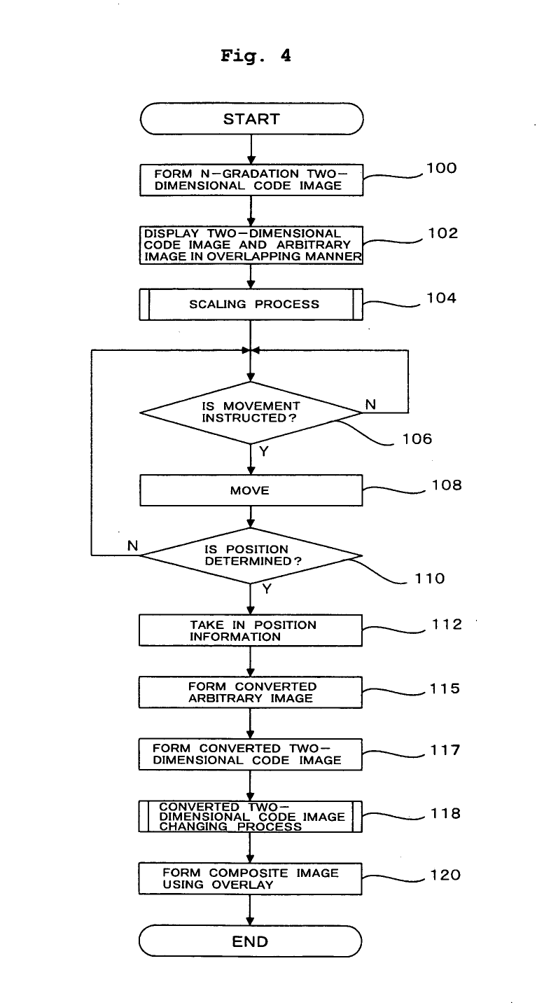

The CPU of the PC 11 in the image forming apparatus 10 according to the embodiment executes an image forming routine shown in FIG. 4. In the image forming routine shown in FIG. 4, steps 115 and 117 are executed instead of the steps 114 and 116 in the image forming routine (see FIG. 2) shown in the first embodiment and a step 118 is added, which is different from the image forming routine according to the first embodiment. Therefore, the steps 115, 117, and 118 are mainly explained below.

At step 115, (I′) a converted arbitrary image 30A where gradations of respective pixels on an overlapping portion of the arbitrary image 30 with the QR code image 20A having color and gradation information about except for white color (R, G, B)=(255, 255, 255) are converted to gradations in the second region of the above-described five divided regions (i) when pixels on corresponding QR code image 20A in the overlapping portion are positioned on the shadow side, and they are converted to gradations in the fourth region (ii) when pixels on corresponding QR code image 20A in the overlapping portion are positioned on the highlight side is formed.

At step 117, (II′) a converted QR code image 20C where gradations of respective pixels on an overlapping portion of the QR code image 20A with pixels on the arbitrary image 30 having color and gradation information are converted to gradations in the second region (i) when pixels on the QR code image 20A are positioned on the shadow side, and they are converted to gradations in the fourth region (ii)when pixels on the QR code image 20A are positioned on the highlight side is formed.

As shown in FIG. 8D, when the converted arbitrary image 30A formed at step 115 and the converted QR code image 20C formed at step 117 are combined using overlay, contrast between a dark region 43 and a bright region 44 on the converted QR code image 20C portion becomes larger than that of the composite image 40 shown in FIG. 8C.

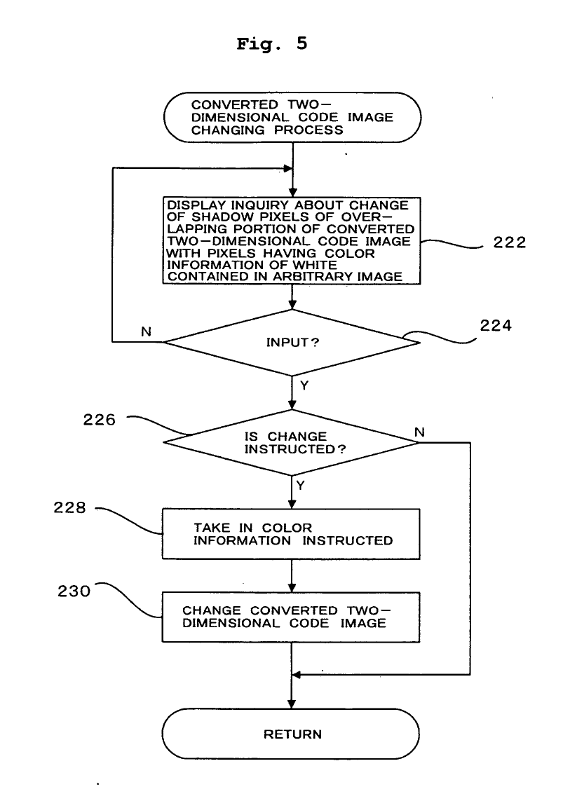

At step 118, a converted two-dimensional code image change processing for changing color and gradation information about respective shadow pixels (R, G, B)=(204, 204, 204) constituting the dark region 43 shown in FIG. 8D is performed. As shown in FIG. 5, in the converted two-dimensional code image change processing, a converted two-dimensional code image change processing subroutine is called.

At step 222, a dialogue for an inquiry about whether shadow pixels of an overlapping portion of the converted QR code image 20C with white color pixels on the arbitrary image 30 are converted, or the like is displayed on the display 12 and the control is put in a standby state until input is received from the input device 15 (step 224). When input is received, determination is made about where a change instruction is issued at step 226. When the determination is negative, the converted two-dimensional code image change processing subroutine is terminated and the control proceeds to step 120 shown in FIG. 4. When the determination is affirmative, the instructed color and gradation information is taken in at step 228 and color of the dark region 43 on the converted QR code image 20C is changed at step 230, the converted two-dimensional code image change processing subroutine is terminated, and the control proceeds to step 120 shown in FIG. 4.

In order to enhance visibility and fanciness, an operator can designate, as color of the dark region 43, color different from color of the arbitrary image 30, for example, color having a opposite hue, but it is preferable that shadow pixels to be changed are put in the second region after they have been changed (even if the shadow pixels to be changed have gradations in the first region after changed, they do not affect taking-in accuracy in a reader), as described above. Therefore, when the pixels do not enter in the second region, the CPU can perform such change that the pixels enter in the second region, or a message box or the like is displayed on the display 12 for notification to an operation. In FIG. 5, in order to explain a key point of the subroutine, displaying on the display 12 is omitted, but the converted QR code images 20C before changed and after changed are displayed on the display 12, of course. The example where change instruction is issued only one time has been explained, but such a constitution may be adopted that the control returns back to step 222 again and an inquiry is issued such that an operator can perform change to a satisfactory color.

At step 120 shown in FIG. 4, a composite image 40A (see FIG. 8D) obtained by combining the converted arbitrary image 30A formed at step 115 and the converted QR code image 20C changed (converted) at step 230 according to overlay is formed.

In the image forming apparatus 10 according to the embodiment, since the converted arbitrary image 30A and the converted QR code image 20C are formed such that contrast between the dark region 43 and the bright region 44 on the converted QR code image 20C portion becomes large (steps 115 and 117), and color of shadow pixels (pixels constituting the dark region 43 shown in FIG. 8D) on the overlapping portion of the converted QR code image 20C with white pixels on the arbitrary image 30 is changed (step 230), a composite image 40A with high visibility and high fanciness can be obtained.

(Third Embodiment)

Next, a third embodiment of the image forming apparatus according to the present invention will be explained. The embodiment is for forming a composite image including a QR code image as background and a converted arbitrary image as foreground.

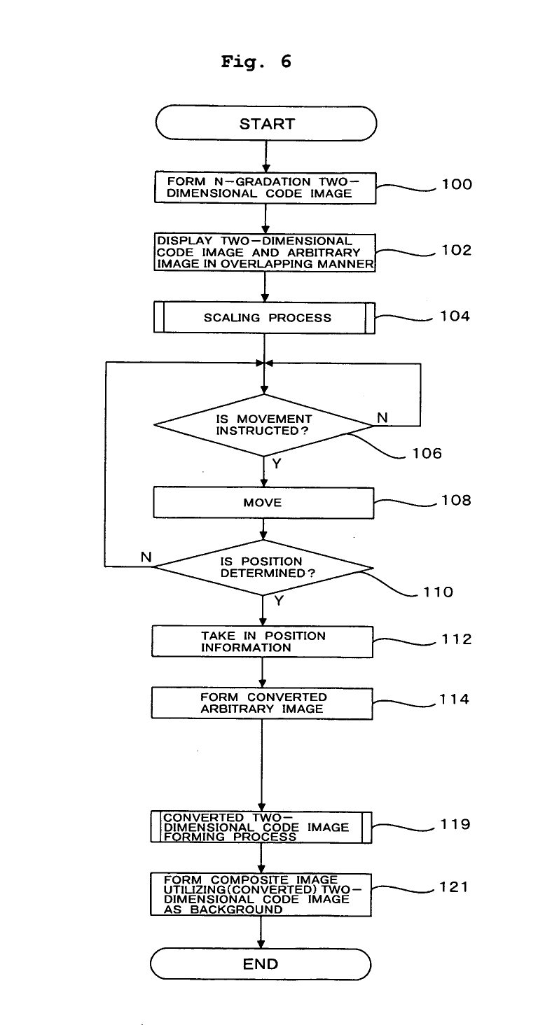

The CPU of the PC11 of the image forming apparatus 10 according to the embodiment executes an image forming routine shown in FIG. 6. The image forming routine shown in FIG. 6 is different from the image forming routine according to the first embodiment in that it does not include the step 116 of the image forming routine (FIG. 2) shown in FIG. 1 but it includes step 119 which is an optional step and step 121 is executed instead of step 120. Therefore, steps 119 and 121 will be explained below.

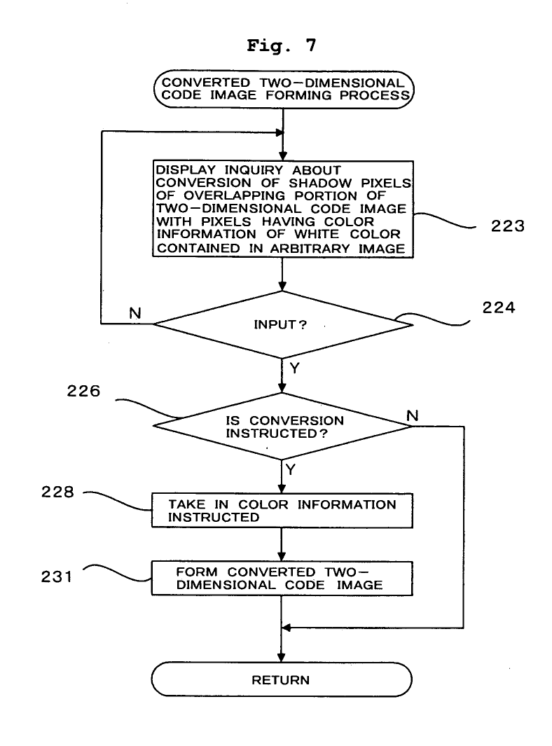

At step 119, a converted two-dimensional code image forming processing corresponding to step 118 shown in FIG. 4 is executed, but a processing performed in the step 119 is optional and it is not an essential step for the present invention. As shown in FIG. 7, in the converted two-dimensional code image forming processing, a converted two-dimensional code image forming processing subroutine is called.

In the converted two-dimensional code image forming processing subroutine, a dialogue of an inquiry about whether shadow pixels of an overlapping portion of the QR code image 20A formed at step 100 with white pixels on the arbitrary image 30 should be converted or the like is displayed on the display 12 at step 223, and the control is put in a standby state until input is received from the input device 15 (step 224). When input is received, determination is made about whether conversion instruction is issued at step 226. When the determination is negative, the converted two-dimensional code image forming processing subroutine is terminated and the control proceeds to step 121 shown in FIG. 6. When the determination is affirmative, the instructed color and gradation information is taken in at step 228, a converted QR code image 20D where color of the dark region 43 on the QR code image 20A is converted is formed at step 231, the converted two-dimensional code image forming processing subroutine is terminated, and the control proceeds to step 121 shown in FIG. 6.

At step 121, a composite image 40B (not shown) obtained by disposing the QR code image 20A formed at step 100 (or the converted QR code image 20D formed at step 231) on a position of the QR code image 20A taken in at step 112 as background and disposing the converted arbitrary image 30A formed at step 114 on a position of the arbitrary image 30 taken in at step 112 as foreground to compose them is formed, the composite image 40B is stored in the hard disk, and the image forming routine is terminated.

In the image forming apparatus 10 according to the embodiment, since the composite image including the QR code image 20A (or the converted QR code image 20D) as background and the converted arbitrary image 30A as foreground is formed (step 121), and the QR code image 20A (or the converted QR code image 20D) is included in the composite image, a person can visually identify the composite image 4OB including the QR code image 20A (or the converted QR code image 20D). Regarding the overlapping portion of the QR code image 20A and the arbitrary image 30 with each other, since the converted arbitrary image 30A where respective pixels on the arbitrary image 30 have been converted in gradations in the second region or the fourth region according to gradations of pixels on the QR code image 20A excluding the third region where an error occurs easily at a time of reading performed by a reader is formed, (the n-gradation two-dimensional code image portion of) the composite image 40B can be read reliably using a reader.

In the image forming apparatus 10 according to the embodiment, since step 116 of forming a converted QR code image 20C shown in FIG. 2 is not included in principle (processing at step 119 is not essential), a composite image can be formed at a faster speed than that in the image forming apparatus 10 according to the first embodiment. In the image forming apparatus 10 according to the embodiment, when processing at step 119 (formation of the converted QR code image 20D) is added optionally, a composite image 40B with high visibility and high fanciness can be obtained like the second embodiment. In that case, contrast of the converted QR code image 20D portion on the composite image 40B may be increased like the second embodiment (see steps 115 and 117 in FIG. 2).

In the above embodiments, an example where a general-purpose PC 11 is used has been explained, but the present invention is not limited to the example. The present invention is applicable to an (exclusive) image forming apparatus where a program such as the above-described application software and program data have been stored in a ROM, of course.

In the above embodiments, an example where a program and program data for an application software have already been installed in the hard disk has been described, but such a program and the like can be recorded in, for example, a CD-ROM, a mass storage disk or a magnet-optical disk, and they may be installed from such a recording medium to the hard disk.

In the above embodiments, the 256 gradation arbitrary image 30 has been illustrated, but the present invention is not limited to the gradation, of course. In that case, it is preferable that the arbitrary image 30 has five or more gradations for allowing securing five (or more) regions, as shown in FIG. 10.

In the above embodiments, the first to fifth regions obtained by dividing 256 gradations into the five regions have been illustrated, but the present invention is not limited to the five regions. For example, such a constitution may be adopted that the 256 gradations are divided into seven regions of first to seventh regions, the fourth region including a central value in the 256 gradations, where an error occurs easily at a time of reading performed by a reader, is excluded and the first and the seventh regions which can not be recommended in view of visibility when images overlap with each other are excluded, and a converted arbitrary image 30A (and the converted QR code image 20C) whose pixels have been converted to gradations in the second region (or the third region) or gradations in the sixth region (or the fifth region) is formed for composition.

In the above embodiments, an example where the first to fifth regions are set by dividing the 256 gradations into the five regions equally has been described, but the present invention is not limited to the example. By adopting such a constitution that the central value in the 256 gradations is included in the third region, the 256 gradations may be divided into the five regions unequally. The respective regions of the five divided regions, especially, the third region can be change according to reading precision of a reader to be used.

In the above embodiments, as shown in FIG. 8, the arbitrary image 30 smaller than the QR code image 20 has been illustrated, but when the arbitrary image 30 is larger than the converted arbitrary image 20A, as shown in FIG. 9A, colors of the arbitrary image 30 (30A) except for white color may be set so as not to overlap with a margin 45 (see FIGS. 8C and 8D) of the composite image 40 (40A, 40B) according to the standard of Non-Patent Literature 1 described above.

### INDUSTRIAL APPLICABILITY

Since the present invention provides an image forming apparatus for forming a composite image obtained by combining a two-dimensional code image and an arbitrary image which is an image having high discrimination and a computer readable medium storing a program used for forming the composite image, the present invention contribute to production and sales of an image forming apparatus and a computer readable medium used for forming a composite image and it has industrial applicability.

What is claimed is:

1. An image forming apparatus comprising:
an image storage which stores a two-dimensional code image and arbitrary n (n≧5)-gradation image therein;
a first converted image forming unit that forms a n-gradation two-dimensional code image obtained by converting the two-dimensional code image stored in the image storage to the same image format as that of the arbitrary image;
a display unit which displays the n-gradation two-dimensional code image produced in the first converted image forming unit and the arbitrary image stored in the image storage on a display in an overlapping manner;
a moving unit which moves at least one of the n-gradation two-dimensional code image and the arbitrary image displayed on the display in the overlapping manner relative to the other thereof based upon input information from an input unit;
a position information acquiring unit which acquires position information regarding the n-gradation two-dimensional code image and the arbitrary image after the movement has been performed by the moving unit;
a second converted image forming unit which forms a converted two-dimensional code image and converted arbitrary image obtained by converting gradations of respective pixels of an overlapping portion of the n-gradation two-dimensional code image and the arbitrary image with each other to predetermined gradations based upon the position information acquired by the position information acquiring unit, and color and gradation information for respective pixels of the n-gradation two-dimensional code image and the arbitrary image; and
a composition image forming unit which forms a composite image obtained by combining the converted two-dimensional code image and the converted arbitrary image obtained in the second converted image forming unit by overlay based upon the position information obtained in the position information acquiring unit, wherein
the second converted image forming unit,
regarding at least five divided regions of a first region, a second region, a third region including a central value of the n gradations, a fourth region, and a fifth region obtained by preliminarily dividing the n gradations of a shadow side to a highlight side, converts gradations of the respective pixels of an overlapping portion of the arbitrary image with the n-gradation two-dimensional code image to gradations within the shadow side except for the first and third regions when corresponding pixels of the n-gradation two-dimensional code image in the overlapping portion thereof are positioned on the shadow side, and converts the gradations of the respective pixels to gradations within the highlight side except for the third and fifth regions when the corresponding pixels of the n-gradation two-dimensional code image in the overlapping portion thereof are positioned on the highlight side; and
converts gradations of respective pixels of a overlapping portion of the n-gradation two-dimensional code image with the arbitrary image to gradations within the shadow side except for the first and third regions of the at least five divided regions when the pixels are positioned in the shadow side, and converts the gradations of the respective pixels to gradations within the highlight side except for the third and fifth regions when the pixels are positioned on the highlight side.

2. An image forming apparatus according to claim 1, wherein the second converted image forming unit,
regarding the five divided regions of the first region, the second region, the third region including a central value of the n gradations, the fourth region, and the fifth region obtained by preliminarily dividing the n gradations of a shadow side to a highlight side, converts gradations of respective pixels of an overlapping portion of the arbitrary image with the two-dimensional code image except for pixels of white color to gradation within the second region when corresponding pixels of the n-gradation two-dimensional code image in the overlapping region are positioned in the shadow side, and converts the gradations of the respective pixels to gradations within the fourth region when the corresponding pixels are positioned on the highlight side; and
converts gradations of respective pixels of an overlapping portion of the n-gradation two-dimensional code image with the arbitrary image except for pixels of white color to gradations within the second region of the five divided regions when the pixels are positioned in the shadow side, and converts the gradations of the respective pixels to gradations within the fourth region when the pixels are positioned on the highlight side.

3. An image forming apparatus according to claim 2, wherein the second converted image forming unit further converts respective shadow pixels of an overlapping portion of the converted two-dimensional code image with white color pixels of the arbitrary image to pixels having arbitrary one color except for the color of the shadow pixels and having gradations within one of the first and second regions.

4. An image forming apparatus according to claim 1, wherein the second converted image forming unit compresses gradations of respective pixels of an overlapping portion of the arbitrary image with the n-gradation two-dimensional code image for each of R, G, and B such that the gradations enter in one of the second region and the fourth region according to whether corresponding pixels of the n-gradation two-dimensional code image in the overlapping portion are positioned on the highlight side or the shadow side.

5. An image forming apparatus according to claim 1, further comprising a scaled image forming unit which forms a scaled n-gradation two-dimensional code image obtained by enlarging or reducing the n-gradation two-dimensional code image formed by the first converted image forming unit, wherein the display unit displays the scaled n-gradation two-dimensional code image formed by the scaled image forming unit and the arbitrary image stored in the image storage on the display in an overlapping manner.

6. An image forming apparatus comprising:
an image storage which stores a two-dimensional code image and arbitrary n (n≧5)-gradation image therein;
a first converted image forming unit that forms a n-gradation two-dimensional code image obtained by converting the two-dimensional code image stored in the image storage to the same image format as that of the arbitrary image;
a display unit which displays the n-gradation two-dimensional code image produced in the first converted image forming unit and the arbitrary image stored in the image storage on a display in an overlapping manner;
a moving unit which moves at least one of the n-gradation two-dimensional code image and the arbitrary image displayed on the display in the overlapping manner relative to the other thereof based upon input information from an input unit;
a position information acquiring unit which acquires position information regarding the n-gradation two-dimensional code image and the arbitrary image after the movement has been performed by the moving unit;
a second converted image forming unit which forms a converted arbitrary image obtained by converting gradations of respective pixels of an overlapping portion of the arbitrary image with the n-gradation two-dimensional code image to predetermined gradations based upon position information acquired by the position information acquiring unit, and color and gradation information for respective pixels of the n-gradation two-dimensional code image and the arbitrary image; and
a composition image forming unit which forms a composite image by combining the n-gradation two-dimensional code image and the converted arbitrary image based upon the position information acquired by the position information acquiring unit such that the n-gradation two-dimensional code image formed in the first converted image forming unit constitutes a background and the converted arbitrary image formed in the second converted image forming unit constitutes a foreground, wherein the second converted image forming unit,
regarding at least five divided regions of a first region, a second region, a third region including a central value of the n gradations, a fourth region, and a fifth region obtained by preliminarily dividing the n gradations of a shadow side to a highlight side, converts gradations of the respective pixels of a overlapping portion of the arbitrary image with the n-gradation two-dimensional code image to gradations within the shadow side except for the first and third regions when corresponding pixels of the n-gradation two-dimensional code image in the overlapping portion thereof are positioned on the shadow side, and converts the gradations of the respective pixels to gradations within the highlight side except for the third and fifth regions when the corresponding pixels of the n-gradation two-dimensional code image in the overlapping portion thereof are positioned on the highlight side.

7. An image forming apparatus according to claim 6, wherein the second converted image forming unit,
regarding the five divided regions of the first region, the second region, the third region including a central value of the n gradations, the fourth region, and the fifth region obtained by preliminarily dividing the n gradations from a shadow side toward a highlight side, converts gradations of respective pixels of an overlapping portion of the arbitrary image with the n-gradation two-dimensional code image except for pixels of white color to gradations within the second region when corresponding pixels of the n-gradation two-dimensional code image in the overlapping region are positioned on the shadow side, and converts the gradations of the respective pixels to gradations within the fourth region when the corresponding pixels of the n-gradation two-dimensional code image in the overlapping portion are positioned on the highlight side.

8. An image forming apparatus according to claim 7, wherein the second converted image forming unit converts shadow pixels of an overlapping portion of the n-gradation two-dimensional code image with white color pixels of the arbitrary image to pixels having arbitrary one color except for the color of the shadow pixels and having gradations within one of the first and second regions.

9. An image forming apparatus according to claim 6, wherein the second converted image forming unit compresses gradations of respective pixels of an overlapping portion of the arbitrary image with the n-gradation two-dimensional code image for each of R, G, and B such that the gradations enter in one of the second region and the fourth region according to whether corresponding pixels of the n-gradation two-dimensional code image in the overlapping portion are positioned on the highlight side or the shadow side.

10. An image forming apparatus according to claim 6, further comprising a scaled image forming unit which forms a scaled n-gradation two-dimensional code image obtained by enlarging or reducing the n-gradation two-dimensional code image formed by the first converted image forming unit, wherein the display unit displays the scaled n-gradation two-dimensional code image formed by the scaled image forming unit and the arbitrary image stored in the image storage on the display in an overlapping manner.

11. A computer readable medium comprising a program for forming a composite image obtained by combining a two-dimensional code image and an arbitrary image, wherein the program comprises:
a program code for generating an image storage which stores a two-dimensional code image and arbitrary n (n≧5)-gradation image therein;
a program code for generating a first converted image forming unit that forms a n-gradation two-dimensional code image obtained by converting the two-dimensional code image stored in the image storage to the same image format as that of the arbitrary image;
a program code for generating a display unit which displays the n-gradation two-dimensional code image produced in the first converted image forming unit and the arbitrary image stored in the image storage on a display in an overlapping manner;
a program code for generating a moving unit which moves at least one of the n-gradation two-dimensional code image and the arbitrary image displayed on the display in the overlapping manner relative to the other thereof based upon input information from an input unit;
a program code for generating a position information acquiring unit which acquires position information regarding the n-gradation two-dimensional code image and the arbitrary image after the movement has been performed by the moving unit;
a program code for generating a second converted image forming unit which forms a converted two-dimensional code image and converted arbitrary image obtained by converting gradations of respective pixels of an overlapping portion of the n-gradation two-dimensional code image and the arbitrary image with each other to predetermined gradations based upon the position information acquired by the position information acquiring unit, and color and gradation information for respective pixels of the n-gradation two-dimensional code image and the arbitrary image; and
a program code for generating a composition image forming unit which forms a composite image obtained by combining the converted two-dimensional code image and the converted arbitrary image obtained in the second converted image forming unit by overlay based upon the position information obtained in the position information acquiring unit, wherein
the second converted image forming unit,
regarding at least five divided regions of a first region, a second region, a third region including a central value of the n gradations, a fourth region, and a fifth region obtained by preliminarily dividing the n gradations of a shadow side to a highlight side, converts gradations of the respective pixels of an overlapping portion of the arbitrary image with the n-gradation two-dimensional code image to gradations within the shadow side except for the first and third regions when corresponding pixels of the n-gradation two-dimensional code image in the overlapping portion thereof are positioned on the shadow side, and converts the gradations of the respective pixels to gradations within the highlight side except for the third and fifth regions when the corresponding pixels of the n-gradation two-dimensional code image in the overlapping portion thereof are positioned on the highlight side; and
converts gradations of respective pixels of a overlapping portion of the n-gradation two-dimensional code image with the arbitrary image to gradations within the shadow side except for the first and third regions of the at least five divided regions when the pixels are positioned in the shadow side, and converts the gradations of the respective pixels to gradations within the highlight side except for the third and fifth regions when the pixels are positioned on the highlight side.

12. A computer readable medium according to claim 11, wherein the second converted image forming unit
regarding the five divided regions of the first region, the second region, the third region including a central value of the n gradations, the fourth region, and the fifth region obtained by preliminarily dividing the n gradations of a shadow side to a highlight side, converts gradations of respective pixels of an overlapping portion of the arbitrary image with the two-dimensional code image except for pixels of white color to gradation within the second region when corresponding pixels of the n-gradation two-dimensional code image in the overlapping region are positioned in the shadow side, and converts the gradations of the respective pixels to gradations within the fourth region when the corresponding pixels are positioned on the highlight side; and
converts gradations of respective pixels of an overlapping portion of the n-gradation two-dimensional code image with the arbitrary image except for pixels of white color to gradations within the second region of the five divided regions when the pixels are positioned in the shadow side, and converts the gradations of the respective pixels to gradations within the fourth region when the pixels are positioned on the highlight side.

13. A computer readable medium according to claim 11, wherein the second converted image forming unit further converts respective shadow pixels of an overlapping portion of the converted two-dimensional code image with white color pixels of the arbitrary image to pixels having arbitrary one color except for the color of the shadow pixels and having gradations within one of the first and second regions.

14. A computer readable medium according to claim 11, wherein compresses gradations of respective pixels of an overlapping portion of the arbitrary image with the n-gradation two-dimensional code image for each of R, G, and B such that the gradations enter in one of the second region and the fourth region according to whether corresponding pixels of the n-gradation two-dimensional code image in the overlapping portion are positioned on the highlight side or the shadow side.

15. A computer readable medium according to claim 11, further comprising a scaled image forming unit which forms a scaled n-gradation two-dimensional code image obtained by enlarging or reducing the n-gradation two-dimensional code image formed by the first converted image forming unit, wherein the display unit displays the scaled n-gradation two-dimensional code image formed by the scaled image forming unit and the arbitrary image stored in the image storage on the display in an overlapping manner.

16. A computer readable medium comprising a program for forming a composite image obtained by combining a two-dimensional code image and an arbitrary image, wherein the program comprises:
an image storage which stores a two-dimensional code image and arbitrary n (n≧5)-gradation image therein;
a first converted image forming unit that forms a n-gradation two-dimensional code image obtained by converting the two-dimensional code image stored in the image storage to the same image format as that of the arbitrary image;
a display unit which displays the n-gradation two-dimensional code image produced in the first converted image forming unit and the arbitrary image stored in the image storage on a display in an overlapping manner;
a moving unit which moves at least one of the n-gradation two-dimensional code image and the arbitrary image displayed on the display in the overlapping manner relative to the other thereof based upon input information from an input unit;
a position information acquiring unit which acquires position information regarding the n-gradation two-dimensional code image and the arbitrary image after the movement has been performed by the moving unit;
a second converted image forming unit which forms a converted arbitrary image obtained by converting gradations of respective pixels of an overlapping portion of the arbitrary image with the n-gradation two-dimensional code image to predetermined gradations based upon position information acquired by the position information acquiring unit, and color and gradation information for respective pixels of the n-gradation two-dimensional code image and the arbitrary image; and
a composition image forming unit which forms a composite image by combining the n-gradation two-dimensional code image and the converted arbitrary image based upon the position information acquired by the position information acquiring unit such that the n-gradation two-dimensional code image formed in the first converted image forming unit constitutes a background and the converted arbitrary image formed in the second converted image forming unit constitutes a foreground, wherein the second converted image forming unit,
regarding at least five divided regions of a first region, a second region, a third region including a central value of the n gradations, a fourth region, and a fifth region obtained by preliminarily dividing the n gradations of a shadow side to a highlight side, converts gradations of the respective pixels of a overlapping portion of the arbitrary image with the n-gradation two-dimensional code image to gradations within the shadow side except for the first and third regions when corresponding pixels of the n-gradation two-dimensional code image in the overlapping portion thereof are positioned on the shadow side, and converts the gradations of the respective pixels to gradations within the highlight side except for the third and fifth regions when the corresponding pixels of the n-gradation two-dimensional code image in the overlapping portion thereof are positioned on the highlight side.

17. A computer readable medium according to claim 16, wherein the second converted image forming unit,
regarding the five divided regions of the first region, the second region, the third region including a central value of the n gradations, the fourth region, and the fifth region obtained by preliminarily dividing the n gradations from a shadow side toward a highlight side, converts gradations of respective pixels of an overlapping portion of the arbitrary image with the n-gradation two-dimensional code image except for pixels of white color to gradations within the second region when corresponding pixels of the n-gradation two-dimensional code image in the overlapping region are positioned on the shadow side, and converts the gradations of the respective pixels to gradations within the fourth region when the corresponding pixels of the n-gradation two-dimensional code image in the overlapping portion are positioned on the highlight side.

18. A computer readable medium according to claim 17, wherein the second converted image forming unit converts shadow pixels of an overlapping portion of the n-gradation two-dimensional code image with white color pixels of the arbitrary image to pixels having arbitrary one color except for the color of the shadow pixels and having gradations within one of the first and second regions.

19. A computer readable medium according to claim 16, wherein the second converted image forming unit compresses gradations of respective pixels of an overlapping portion of the arbitrary image with the n-gradation two-dimensional code image for each of R, G, and B such that the gradations enter in one of the second region and the fourth region according to whether corresponding pixels of the n-gradation two-dimensional code image in the overlapping portion are positioned on the highlight side or the shadow side.

20. A computer readable medium according to claim 16, further comprising a scaled image forming unit which forms a scaled n-gradation two-dimensional code image obtained by enlarging or reducing the n-gradation two-dimensional code image formed by the first converted image forming unit, wherein the display unit displays the scaled n-gradation two-dimensional code image formed by the scaled image forming unit and the arbitrary image stored in the image storage on the display in an overlapping manner.
